(19) United States
(12) Patent Application Publication
(10) Pub. No.: US 2013/0033955 A1
(43) Pub. Date: Feb. 7, 2013

(54) Processes and apparatus for making concrete and concrete products

(71) Applicants: Richard Sealy Clayton, Fairview, UT (US); Robb Scott Miller, West Point, UT (US); Michael D. Welch, Clearfield, UT (US); Andy Max Cox, Manti, UT (US); Jaiden Thomas Olsen, Manti, UT (US)

(72) Inventors: Richard Sealy Clayton, Fairview, UT (US); Robb Scott Miller, West Point, UT (US); Michael D. Welch, Clearfield, UT (US); Andy Max Cox, Manti, UT (US); Jaiden Thomas Olsen, Manti, UT (US)

(73) Assignee: RRAM-Crete, LC, Alpine, UT (US)

(21) Appl. No.: 13/573,473

(22) Filed: May 28, 2012

Related U.S. Application Data
(60) Provisional application No. 61/486,768, filed on Jun. 13, 2011.

(51) Int. Cl. B28C 5/00

(52) U.S. Cl. 366/6; 366/40

(57) ABSTRACT

A process for making concrete includes treating water with ions and/or ozone to form treated water, and mixing the treated water with aggregate and cement. A system for making concrete includes means for treating charging water with ions, ozone and/or charged particles to form treated water, and means for mixing the treated water with aggregate and cement.

### CROSS-REFERENCE TO RELATED APPLICATION

A claim for priority under 35 U.S.C. § 119(e) is hereby made to U.S. Provisional Patent Application No. 61/486,768, filed on Jun. 13, 2011, titled “Concrete Product,” the entire disclosure of which is, by this reference, hereby incorporated herein.

### TECHNICAL FIELD

The present invention relates generally to processes and apparatuses for making concrete and concrete products. More particularly, the present invention relates to processes and apparatuses for making concrete using water that has been treated with electricity, electrical currents and/or ozone.

### BACKGROUND OF RELATED ART

Concrete is used in a large variety of construction projects, including commercial and residential buildings, highways, bridges, towers, dams, pools, parking structures, pipes, fences and many more structures. Important characteristics of concrete in such structures include its durability, strength and longevity. These characteristics can be compromised by various factors as concrete is mixed or while fabricating structures from concrete, as well as by external factors, such as exposure of the concrete to ice, salt, chemicals and other natural and man-made substances.

Regarding strength, particularly for vertical placements formed from concrete, such as pre-cast structures, walls and columns, steel reinforcements, such as rebar and tension cables, are commonly used to enhance the tensile strength of the vertically oriented structures. In horizontal placements, such as for highways and foundations, durability and longevity become major problems, because the concrete structures are exposed more directly to rain, snow, ice, salt and other chemicals. Degradation of the concrete can occur rapidly when exposed to such elements, resulting in deterioration, peeling, pot marks and general strength reduction. When concrete deteriorates, its structural integrity, as well as its appearance, can be affected.

Concrete is a composite construction material composed primarily of aggregate, cement and water. The aggregate is generally a coarse gravel or crushed rock, mixed with sand. The cement, is typically a mixture of oxides of calcium, silicon and aluminum and a source of sulfate, usually gypsum. Cement serves as a binder for the aggregate. Water is a key ingredient in that it enables the material to flow so the concrete can be shaped prior to curing and hardening. The water also enables the cement to bind the aggregate and make an extremely hard material when cured.

Many attempts have been made to improve the strength and durability of concrete. Various additives have been included in the mix with scattered results. Some additives are included for other reasons. Accelerators speed up hydration, retarders slow it down. Plasticizers can serve as water reducers, and bonding agents facilitate bonding between old and new concrete.

The relative proportion of aggregate, cement and water has been found to affect the strength and the durability of concrete products. For example, if less water is used, up to a point, the result will generally be a stronger, more durable product. More water will provide a more free flowing concrete but with a higher slump and can lead to premature deterioration. Coarser aggregate generally tends to increase the strength of concrete. However, larger aggregate tends to not distribute as evenly as sand, particularly in the presence of vibration, which can cause undesirable strength gradients throughout the concrete. It has also been found that premixing water and cement before adding aggregate can increase the compressive strength of the concrete.

Despite the above improvements, the problems of durability and strength persist. Weakened concrete, and the damage it causes to infrastructures, such as buildings and bridges, can be particularly critical problems, as has been seen in recent years with the untimely collapse of buildings and bridges and the resulting death and destruction.

### SUMMARY

The present invention relates to methods and processes for increasing the strength, durability and longevity of concrete structures. In various embodiments, the present invention includes methods for making concrete. Such methods comprise charging water to generate ions and/or other charged particles. The resulting water may be referred to as “charged water.” The charged water is mixed with with aggregate and cement. In addition, the present invention involves a system for making concrete, comprising means for charging water with ions and/or other charged particles to form charged water, and means for mixing the charged water with aggregate and cement.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIG. 1 is a block diagram of a system for improving concrete according to the present invention;

FIG. 2 is an electrical schematic diagram showing one embodiment of an inverter that may be included in the system shown in FIG. 1;

FIG. 3 is a mechanical schematic diagram showing one embodiment of a pipe bank electrolysis system that may be included in the system shown in FIG. 1;

FIG. 4 is a mechanical diagram showing another embodiment of a pipe bank electrolysis system that may be included in the system shown in FIG. 1;

FIGS. 5 and 6 are mechanical cross-section diagrams showing an embodiment for applying an electrical charge to a concrete slurry, according to the present invention;

FIG. 7 is a block diagram showing the use of an ozone generator system, according to the present invention;

FIG. 8 is a block diagram depicting the combination of the pipe bank electrolysis system shown in FIG. 3 and the ozone generator system of FIG. 7, according to the present invention; and

FIG. 9 is a diagram showing an electrolysis tank according to the present invention.

### DETAILED DESCRIPTION

### Overview

The disclosed embodiments of the present invention utilize processes that apply an electrical current or electrical charges to water or that otherwise introduce ions into water. Such processes may be used to prepare water that is to be used to make concrete or they may be applied to a concrete slurry after mixing. The result is substantially stronger and more durable concrete. The process by which that result is achieved is not entirely understood, but it is believed that applying electricity to water or a water mixture during the concrete-making process causes some electrolysis of the water, that is, a separation of water into unstable hydrogen and oxygen components. These components include H⁺, OH⁻, O₃, O₂, H₂, H₂O₂, H₃O⁺ and many others.

Most of these components are unstable, and quickly react with whatever suitable reactants are available to form more stable molecules. As water typically has impurities in it, the application of electricity may also generate ions from the impurities. It is believed that the presence of ions in the charged water tends to interact with the cement and aggregate to accentuate the binding process carried out by the slurry mixture.

As an example, some cement has a combination of tri-calcium silicates and bi-calcium silicates, both of which are candidates to combine with the aggregates. Typically, tri-calcium silicates react quicker and build structure faster than the bi-calcium silicates because tri-calcium silicates are more likely to bond than bi-calcium silicates. The result might be that 80-90% of the tri-calcium silicates form a bond, whereas only about 15-20% of the bi-calcium silicates bond. Thus, the total bonding potential of the cement is not fully realized.

Using the processes of the present invention, many additional ions are present, as described above, so that a high percentage of the bi-calcium silicates will bond, as well as the tri-calcium silicates. The result is concrete that may be almost twice as strong as standard concrete prepared from the same batch. Thus, the present invention has the potential to make extremely strong concrete using ordinary batches of cement and aggregate.

One of the above mentioned unstable components, O₃ or ozone, can be generated independently of electrolysis, using conventional ozone generators such as corona discharge generators or cold plasma generators. In addition to ozone, ozone generators may generate ions and/or free radicals. Cold plasma generators are particularly well suited for generating ozone and, possibly, ions and/or free radicals, for use in a method of the present invention, since they do not require an appreciable current and there is no arcing or burnout when they are used to form ozone.

In one embodiment, an ozone generator may communicate with the flow of water used for making cement. As a result, ozone and possibly ions and/or free radicals may be injected into the water. The charged water is then combined with other materials, primarily cement and aggregate that may be used for making concrete. After the components of the concrete are combined, including the charged water, the concrete can be poured in any application.

In another embodiment, water is exposed to an electrical charge or an electrical current prior to mixing the water with cement and other materials (e.g., aggregate, other components of the concrete being formed, etc). The manner in which an electrical charge or current is applied to water may be accomplished in several different ways. The electrical charge or current may be applied as alternating current, as direct current or some variation of both. After the various components of the concrete are combined, including charged water, the concrete can be poured in any application.

In yet another embodiment, ozone, ions and/or an electrical charge or electrical current may be applied to a concrete slurry after the water and some or all of the other components that are used to make concrete have been mixed. In still another embodiment, water that has been exposed to an electrical charge or an electrical current or to ozone may be added, by spray or otherwise, to concrete shortly after the concrete has been poured (i.e., while at least some of the exposed concrete is uncured, before any significant curing of the exposed concrete occurs, etc.).

Because of the manner in which ozone chargers provide ozone, and possibly ions and/or free radicals, they may be used to charge water or water mixtures before the water is mixed with other components and/or after mixing the water with other components. Ozone may be generated in or an electrical charge or current may be applied to water or water mixtures as they flow through electrically charged elements, such as a cathode-charged pipe with water running therethrough and having an anode-charged tube inside the pipe. As an alternative, ozone may be generated or an electrical charge or current may be applied to water in a static water tank for a selected period of time.

### Electrically Treated Water Through Bank of Water Pipes

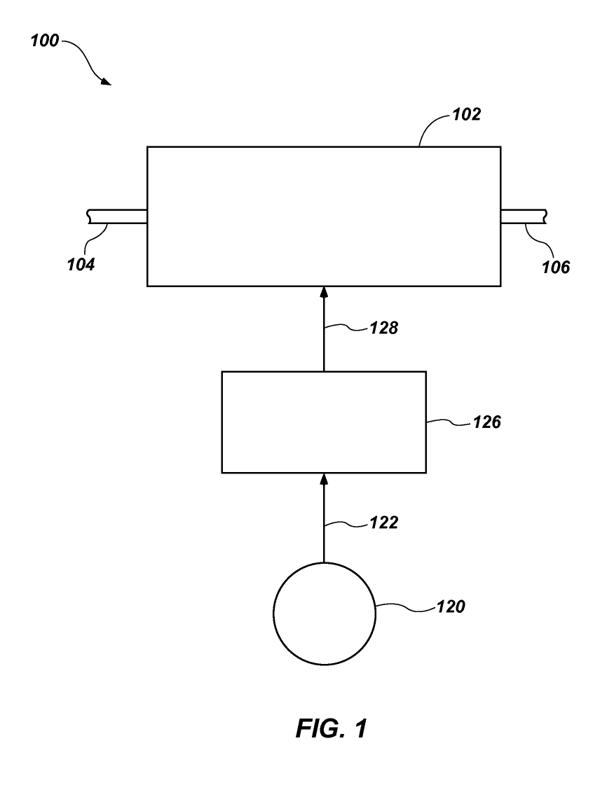

Referring to FIG. 1, a block diagram is shown depicting a water treatment system 100 for electrically treating water to be used in making concrete. Water flows into a water treatment unit 102 at inlet 104 as untreated water and exits at 106 as water that has been electrically treated. Electrical current is provided by a conventional generator 120, such as a 220 volt alternating current (AC) generator. One such conventional generator is an arc welder generator available from the General Electric Company as model 6wk2c.

The electrical current generated by generator 120 is provided via line 122 to a converter unit 126, which converts the electricity from generator 120 to a type of electrical current that is appropriate for the water treatment system 100. The treated electricity then flows on line 128 to the water treatment system 102.

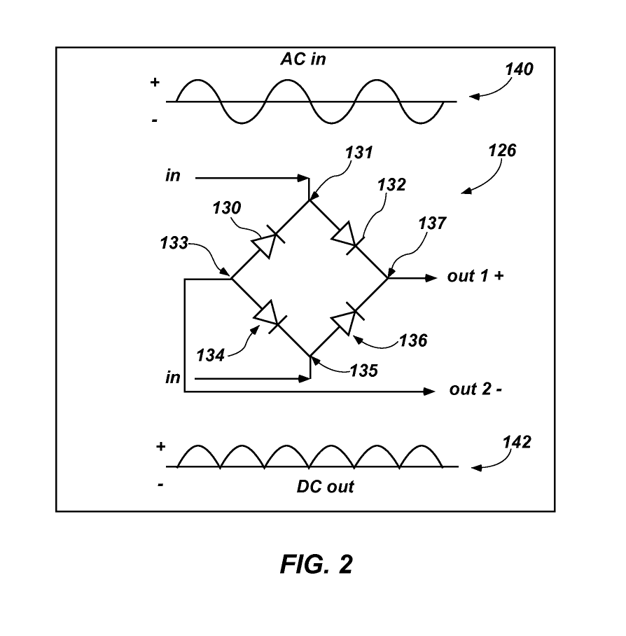

FIG. 2 is an electrical diagram showing one embodiment of the converter unit 126 as a full-wave rectifier circuit. Four diodes 130-136 are connected in a bridge circuit so that an AC power input, shown at 140, can be rectified to a pulsating direct current (DC) power shown at 142, having positive and negative DC component outputs. Diodes 130 and 132 are connected in series at junction 131, and diodes 134 and 136 are connected in series at junction 135. The AC power is input to junctions 131 and 135 as shown. Diodes 130 and 134 are connected in opposing series at junction 133, and diodes 132 and 136 are connected in opposing series at junction 137. The pulsating DC power is obtained by output connections at junctions 133 and 137. Output 1 provides the positive pulsating DC power shown at 142, and output 2 provides a minor-image negative pulsating DC power (not shown).

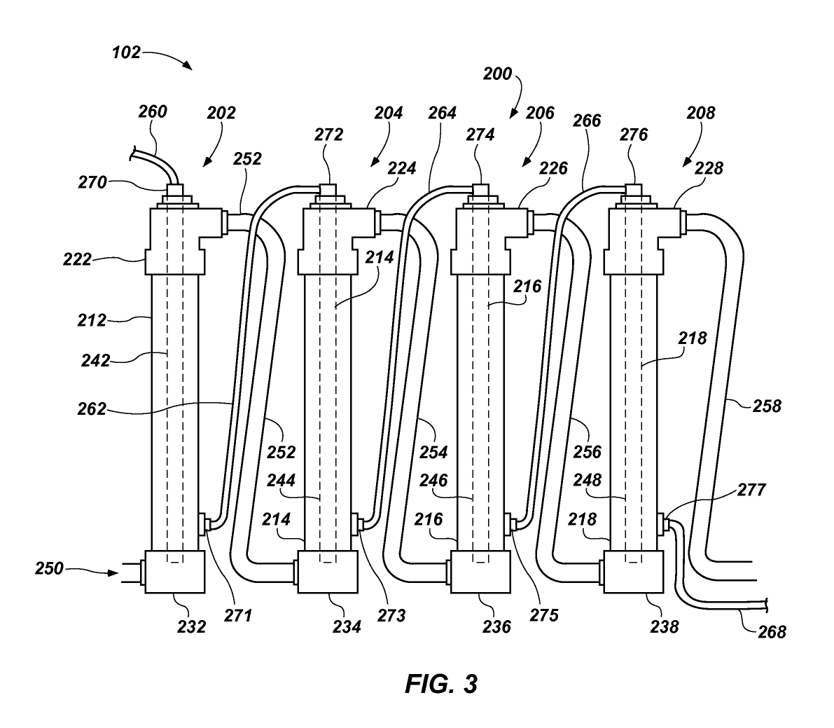

Looking now at FIG. 3, one form of water treatment unit 102 is shown in more detail. A bank 200 of four water treatment pipes is shown, in which the water runs serially through each four pipe units 202, 204, 206 and 208. Specifically, pipe unit 202 is composed of a hollow pipe 212 connected between a top cap 222 and a base cap 232. Additional top caps 224, 226 and 228 are connected to the tops of pipes 214, 216 and 218. Additional base caps 234, 236 and 238 are connected to the bottoms of pipes 214, 216 and 218. A solid rod 242 is disposed concentrically within pipe 212 and runs for most of the length of pipe 212. Additional rods 244, 246, 248 are disposed within each of pipes 214, 216, and 218, respectively.

A water inlet 250 is connected to base joint 214 to provide access for water flow to pipe 242. A connection tube 252 is connected between top cap 222 of pipe 212 and the base joint 234 of the next pipe 214. Likewise, additional connection tubes 254, 256 and 258 are connected between the top caps 224, 226 and 228 of the respective pipes 214, 216 and 218. Connection tube 258 runs from the last pipe unit 208 to conduct water out of water treatment bank 200.

In bank 200, there are also electrical wires that connect the four pipe units 202, 204, 206 and 208 in electrical series. However, the electrical connections are set up in each pipe unit with a first input into the first of the rods and a second input into the last of the pipes. Consequently, there is no electrical current flow until water flows through the pipes to conduct current from each rod to its respective pipe.

Specifically, an electrical input wire 260 connects from an external power source (not shown) into a terminal 270 at the top of top cap 222 associated with pipe 212. Another wire 262 runs from a base terminal 271 at the bottom of pipe 212 to a top terminal 272 on top cap 224. A wire 264 runs from a base terminal 273 on pipe 214 to a top terminal 274 on top cap 226. Another wire 266 runs from a base terminal 275 to a top terminal 276 on top cap 228. Finally a second input wire 268 runs to a base terminal 277 for the water treatment bank 200.

It can be seen that water flows serially through the pipe units 202, 204, 206 and 208. The water flow begins at inlet 250 and flows into pipe unit 202 via base cap 232, up through pipe 212 and out tube 252. The water flow continues into pipe unit 204 via base cap 234, up through pipe 214 and out tube 254. Next the water flows into pipe unit 206 via base cap 236, up through pipe 216 and out tube 256. Finally water flows into pipe unit 208 via base cap 238, up through pipe 218 and out of tube 258.

The electrical current being applied is the positive and negative pulsating DC power from the converter shown in FIG. 2. Accordingly, the positive pulsating DC power output 1 and the negative pulsating DC power output 2 shown in FIG. 2 are connected to input wire 260 and output wire 268, respectively, shown in FIG. 3. When water is flowing in the pipe bank 200, the pulsating DC power flows into unit 202 via wire 260, through the flowing water in rod 242 and out wire 262. The current continues to flow into pipe unit 204 via wire 262, through the flowing water in rod 244 and out wire 264. The electrical current continues to flow into pipe unit 206 via wire 264, through the flowing water in rod 246 and out wire 266. Finally the electrical current flows into pipe 208 via wire 266, through the flowing water in rod 248 and to the second input wire 268.

In the foregoing system discussed with respect to FIGS. 1-3, the electrical connection between each pipe unit is wired in series, so that a positive pulsating DC power is applied at one wire input of the pipe unit and the a negative pulsating DC power is applied at the other wire input of the pipe unit. This alternating pulsating action of the DC power causes the input current to alternate between first input wire 260 to second input wire 268. Accordingly, the rods and pipes in unit 200 vary from functioning as an anode and functioning as a cathode, so that the polarity of the electrolysis action in the pipe unit is constantly being reversed. The result is a substantial reduction in deterioration of the system due to electrolysis.

In one embodiment of the system shown in FIGS. 1-3, the pipes are made of cast iron and are each 31 inches long and 2.5 inches in diameter. The rods are made of copper and are each 31 to 36 inches long and one inch in diameter. The AC power generated by the generator 120 may be 5 amps at 220 volts. The pumping speed of the water may be 4.5 gallons per minute. Using these parameters, it has been found that the resulting concrete made using water charged in the above system may be close to twice as hard as concrete made with uncharged water.

It should be appreciated that several factors are in play, including the size of the pipes and rods, the amount of electrical current and voltage being applied, the pumping speed of the water and the electrolyte content of the water. It is important to balance all of these variables in order to achieve optimal exposure of the water to the electrical current so that the desired amount of charged ions are created in the water to increase the hardness of the resulting concrete. For example, the supplied current may vary from 4 amps to 124 amps and beyond, if needed. The flow rate of the pumped water may vary from 4 gallons per minute up to, and even above, 25 gallons per minute. The size and number of the pumps and rods can vary over an unlimited range.

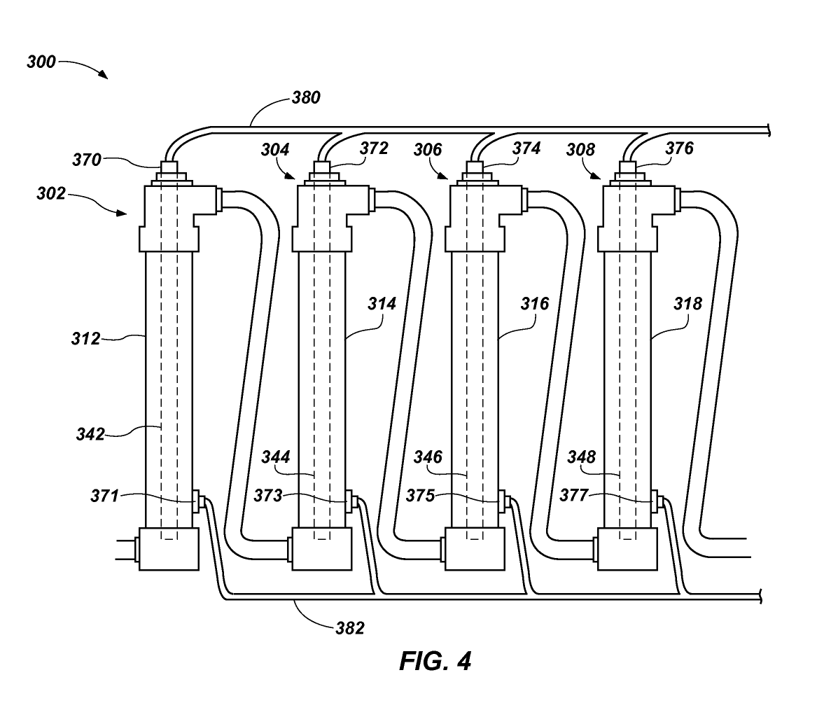

FIG. 4 shows a bank 300 of four water pipe units 302, 304, 306 and 308, having a water flow arrangement identical the water pipe units 202, 204, 206 and 208 shown in FIG. 3. The only difference is that the electrical connection is in parallel rather than being in series. Specifically, each of rods 342, 344, 346 and 348 are connected through their respective top terminals 370, 372, 374 and 376, respectively, to a common input wire 380. Likewise, bottom terminals 371, 373, 375 and 377 are each connected between one of pipes 312, 314, 316 and 318 respectively, and a common output wire 382.

Accordingly pipe units 302, 304, 306 and 308 are electrically connected in parallel rather than in series. It has been determine that this type of electrical connection does not enable the rods and pipes to change from anodes to cathodes. As a result, the deterioration of the pipes and rods is substantially more rapid than with the series connected system shown in FIG. 3.

### EXAMPLE 1

### Using Bank of Electrically-Charged Water Pipes

A test run was performed using the water treatment bank of series four electrically-charged water pipes shown in FIG. 3. The cast iron pipes were each 31 inches long and 2.5 inches in diameter. The copper rods were each 36 inches long and one inch in diameter. The AC power generated by the generator 120 was about 5 amps at 220 volts. The pumping speed of the water was 4.75 gallons per minute.

The treated water was run through the through the bank of four water pipes and then collected, which required about three minutes. The amount of treated water was initially 2,000 milliliters (ml) (30% of the dry volume), that is about 0.5 US gallons. The treated water was immediately mixed with about 25 pounds cement composition taken from a 60 pound bag of dry mix of concrete, sand and gravel or stone sold as QUIKRETE® 1101. However, the resulting batch was too thick, so 500 ml more treated water was applied (total 41.7% of dry volume), for a total of 2,500 ml, or about 0.66 US gallons. Mixing was done with a small conventional portable mixer. The resulting slurry was then placed in two core sample canisters (4 inches diameter, 8 inches in length) to cure.

Untreated tap water in a volume of 1,800 ml (30% of dry volume), or about 0.48 US gallons, was mixed with about 25 pounds of cement composition taken from the same 60 pound bag of dry mix of concrete, sand and gravel or stone sold as QUIKRETE® 1101. Mixing was done with the same portable mixer. The resulting slurry was likewise placed in two core sample canisters of the same size as for the treated samples.

There was a noticeable difference in the formation of the concrete slurries. The slurry batch formed with the treated water reacted more aggressively with the concrete composition than the untreated water, which is why more treated water was needed for the treated batch. Moreover, more water came to the surface during curing for the treated batch, making it easier to work and finish with a trowel.

In both cases, the ambient temperature was about 50° F. The core samples were placed in an enclosure after mixing and remained at about 72° F. for 24 hours.

The samples were tested by AGEC Applied Geotech in Sandy, Utah for breakage. One of each sample was broken 8 days after batching and the other of each sample was tested 28 days after batching. The results are given as follows:

| | Compression | |
|---|---|---|
| Sample Testing | Strength (PSI) | Max Load (lbs) |
| 8-day break test - | 3,290 | 41,260 |
| Concrete with treated water | | |
| 8-day break test - | 1,690 | 21,260 |
| Concrete with untreated water | | |
| 28-day break test - | 4,700 | 59,010 |
| Concrete with treated water | | |
| 28-day break test - | 2,410 | 30,300 |
| Concrete with untreated water | | |

Thus, after 8 days, the concrete made with the treated water was 194% as strong as the concrete made with the untreated water, both in compression strength and in maximum load. After 28 days, the concrete made with treated water, in testing for both compression strength and maximum load, was 195% as strong as the concrete made with the untreated water. It was also noted that the concrete made from treated water had substantially no shrinkage, whereas the concrete made from untreated water had noticeable shrinkage.

### Electrically Treated Slurry

In another embodiment of the present system, an electrical current is applied to a concrete slurry after water has been mixed with the concrete mix and any additionalaggregate. This electrical treatment of the slurry can be in addition to or in place of the electrical charging of the water discussed above.

The concrete slurry may be treated in a stand-alone unit or included as part of a concrete truck system in a mobile application. In the concrete truck mobile system, the mixed slurry may be placed in a cement truck for transportation to a site for installation. The batched slurry is fed into a hopper on the pump truck. The hopper has a mixer that drives the slurry into the bottom of the hopper prior to pumping. The hopper feeds the concrete through a pump that applies pressure to a pipe column, forcing the concrete slurry through a lubricated pipe.

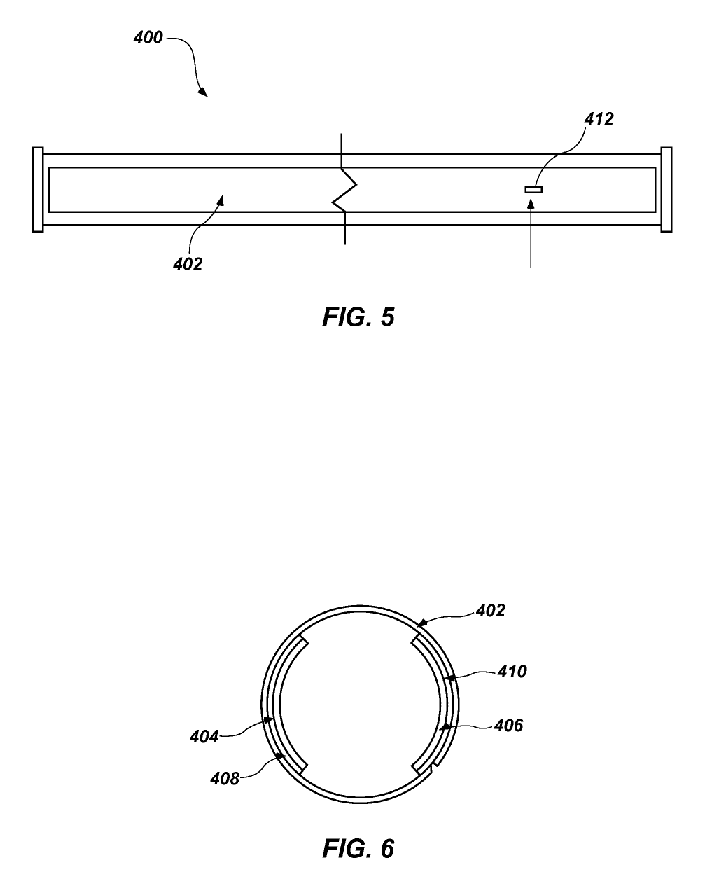

Referring now to FIGS. 5 and 6, a straight pipe system 400 of the type described above is show, except that the pipe 402 has been modified to electrically charge the slurry. FIG. 5 shows a longitudinal cross section of pipe 402. FIG. 6 provides a lateral cross-section of the pipe 402. As best seen in FIG. 6, curved plates 404 and 406 are adhered to the inside of pipe 402 by an adhesive composite 408 and 410. Curved plates are preferably made of tungsten or other conductive material and extend alone a substantial portion of pipe 402. As shown in FIG. 5, plates 404 and 406 are connected to the positive and negative leads of a DC power source located on the truck and driven by the onboard generator. Accordingly, one plate becomes the anode and the other becomes the cathode.

As the slurry passes between the long plates 404, 406 on the inside of the pipe 402, the slurry is charged by the electrolysis conditioning process described above. When the slurry comes out of the dump truck pipes, it has been treated according to the present invention.

### Ozone Treated Water

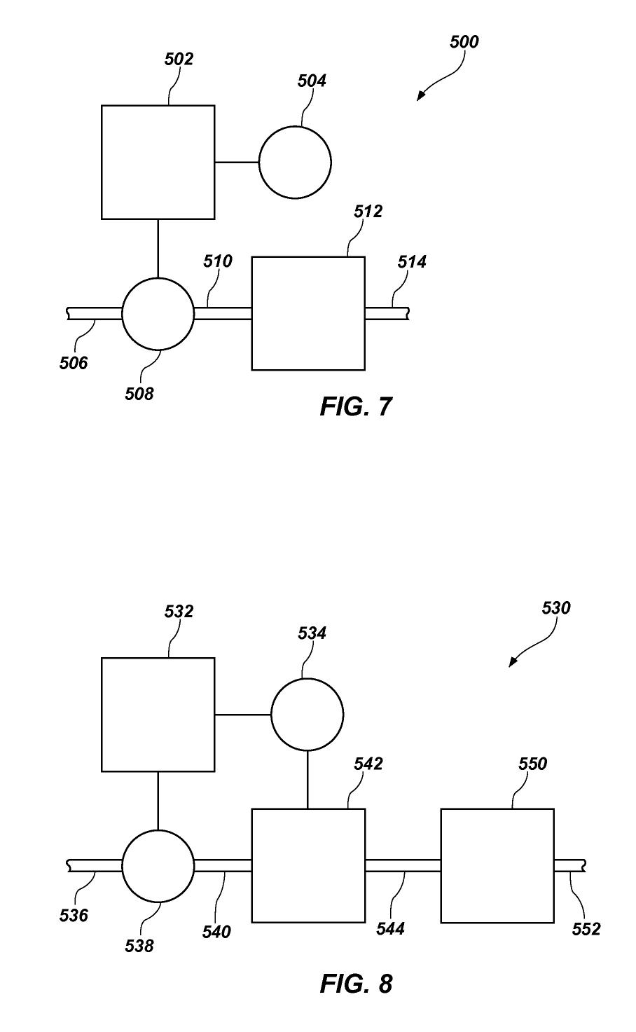

Referring next to FIG. 7, a process and system 500 of the present invention is shown in which ozone is generated separately from electrolysis and is injected directly into water that is used for making concrete. A conventional ozone generator 502 may be used, such as a conventional cold plasma ozone generator, powered by a conventional power source 504. In the embodiment shown, a water line input 506 brings water from a main water line to mixing station 508. Ozone from ozone generator 502 is injected into mixing station 508 so the water becomes infused with ozone, as discussed above. The charged water is then pumped via pipe 510 into a conventional batch concrete plant 512 where the charged water is mixed with concrete mix and any additional aggregate and, optionally, other ingredients and then output for application at 514.

### EXAMPLE 2

### Using Ozone Generator

A test run was performed using an ozone generator, as shown in FIG. 7. A conventional ozone generator was used, namely model number HP-200, a corona discharge unit made by Ozone Solutions, Inc. in Hull, Iowa. This generator operates at a voltage of 120 volts at 60 cycle alternating current and provides ozone at a rate of 200 mg per hour, at a pressure of 2-3 psi. Other conventional ozone generators may be used, including without limitation, those found at www.ozonesolutions.com.

The water was treated by injecting ozone from the ozone generator through a diffuser into five gallons of water for about 11 hours. One gallon of the treated water was then mixed with 60 pounds of QUIKRETE® cement composition. The resulting slurry showed excellent workability and was collected into three sample canisters of the type discussed in Example 1.

A gallon of untreated water was mixed with 60 pounds of QUIKRETE® cement composition. The resulting slurry did not demonstrate workability that was as good as the slurry with the treated water. Additionally, it was more difficult to mix the water with the cement composition, compared to the slurry with the treated water.

The samples were tested by CMT Engineering Laboratories in Salt Lake City, six days after mixing. The documented results showed that the concrete sample made with water treated with ozone broke at 3,064 psi. The concrete sample made with untreated water broke at 1,292 psi. Thus, the concrete made with ozone treated water yielded a 137% increase in strength over, or 237% as strong as, the standard concrete.

Other embodiments of the present invention may involve combining any of the systems shown in this application to enhance the water treatment further. For example, referring to FIG. 8, the ozonation of water, such as shown in FIG. 7, may be combined with the ionization of water, such as shown in FIG. 3, to increase the effectiveness of the treated water. In that combined system 530, an ozone generator 532 powered by a conventional power source 534 generates ozone that is introduced into water brought in from a main water line 536 to a mixing station 538. The treated water is then pumped via pipe 540 into an electrolysis system 542 of the type shown in FIG. 3 to enhance the treated water. The enhanced treated water is then pumped via pipe 544 to a conventional batch concrete plant 550 where the enhanced treated water is mixed with concrete mix and any additional aggregate and, optionally, other ingredients and then output for application at 552.

It should be understood that the order of processing shown in FIG. 8 can also be reversed so that water is first run through an electrolysis system and is then charged with ozone.

### Electrically Treated Water in Electrolysis Tank

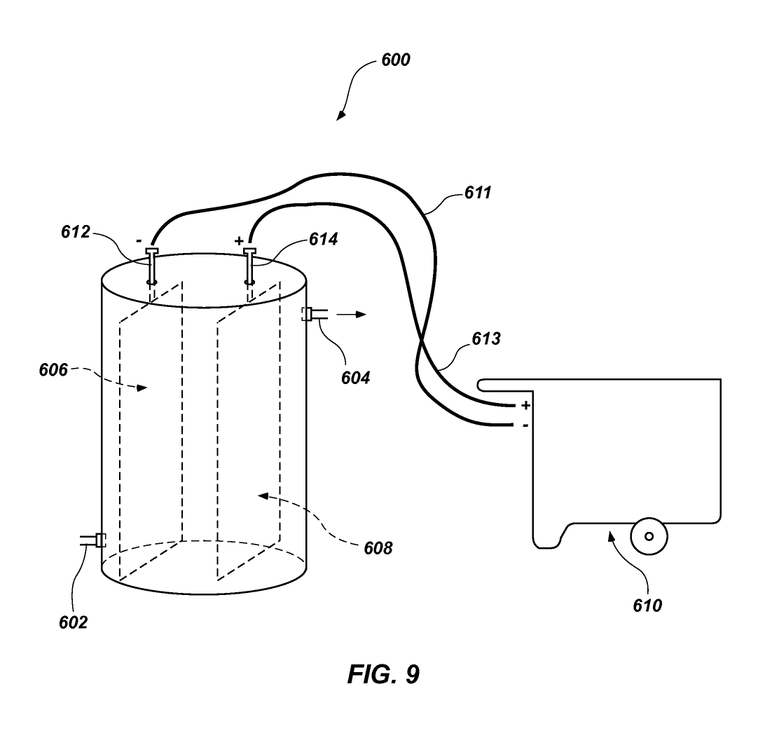

Referring to FIG. 9, in another embodiment of the present invention, water is subjected to electrical charging in a conventional electrolysis tank 600, prior to being mixed with concrete mix and any additional aggregate. In this embodiment water is pumped through a one-way valve 602 into the tank and later removed from an input opening 604. Copper plates 606 and 608 are positioned in tank 600 spaced from each other. A generator 610 has output wires 611 and 613 providing DC power to connectors 612 and 614 that are attached to plates 606 and 608, respectively. A positive DC power is applied to plate 606, making it the cathode, and a negative DC power is applied to plate 608, making it the anode.

Tank 600 may be equipped with other items, such as a propeller (not shown) to move the water around and thereby enhance the charging effect of the system. Additional plates may be added as needed. Moreover, it should be understood that the tank system shown in FIG. 9 may be combined with an electrolysis dynamic flow system, such as shown in FIG. 3, as well as with an ozone generator system, such as shown in FIGS. 7 and 8. For example, water may be charged using a dynamic flow system and then transported to another site for batch processing. In that situation, one may want to use electrolysis tank system, such as shown in FIG. 9 to maintain the charge on the water until it can be used for batch processing.

### EXAMPLES 3, 4 and 5

### Treating Water With an Electrolysis Tank

### EXAMPLE 3

A five gallon plastic tank was filled with water. Two electrodes were attached to a 6,000 watt generator of DC power providing about 30 amps of current. The electrodes were inserted into the water, and the water was treated by placing the activated electrodes in the tank for about 3 to 5 minutes. The treated water was then mixed with a bag of QUIKRETE® concrete mix and with additional aggregate and cured to form an improved concrete sample. The same process was followed with untreated water and the same concrete mix and aggregate to form a standard concrete sample. The improved concrete sample showed 25% greater strength than the standard concrete sample using standard psi measurements. Both samples were subjected to salt, freeze and thaw conditions for 20 days. At the end of the trial period, the improved concrete sample was still intact, and the standard concrete sample had deteriorated into sand and gravel.

### EXAMPLE 4

The same approach as that described in reference to EXAMPLE 1 was used, except a 12 volt, 300 amp battery charger was used to apply electrical current through the electrodes to the tank of water for about 20 hours. Substantially the same results were achieved, showing that the improved concrete sample was much better than the standard concrete sample.

### EXAMPLE 5

The same batch of water, aggregate and concrete mix was used as that disclosed in reference to EXAMPLE 3. However, standard untreated water was used to form the mixture. After the components were mixed, while the mixture was still in a flowable state, an electrical current of the type described in EXAMPLE 3 was applied to the mixture. The result was that the improved concrete sample was only about 5 to 7% stronger than the standard concrete sample.

As can be seen from the foregoing, various embodiments of the present invention provide substantial improvements over prior systems. Electrical charging of water can be carried out by electrolysis in a pipe flow system, an electrolysis tank and any other conventional electrolysis system. In addition, water may be treated using an ozone generator to introduce ozone into the water. Further a concrete slurry may be treated using to above mentioned methods. Any combination of the foregoing processes may also be used to treat water prior to mixing it with cement and/or concrete or to treat a slurry of water and cement or concrete.

The result of any of the foregoing processes provides a substantially improved concrete, both in hardness and in durability, for very little additional cost.

Although the above embodiments are representative of the present invention, other embodiments will be apparent to those skilled in the art from a consideration of this specification and the appended claims, or from a practice of the embodiments of the disclosed invention. It is intended that the specification and embodiments therein be considered as examples only, with the present invention being defined by the claims and their equivalents.

What is claimed:

1. A process for making concrete, comprising:
treating water with ions or ozone to form treated water; and
mixing the treated water with aggregate and cement.

2. The process of claim 1, wherein treating comprises treating the water in an electrolysis tank.

3. The process of claim 1, wherein treating comprises exposing the water to an electrical current while the water flows through an electrolysis system.

4. The process of claim 2, wherein treating comprises flowing the water through a series of charged pipes.

5. The process of claim 4, further comprising applying an electrical charge to each pipe of the series of pipes to generate an electrical charge thereon.

6. The process of claim 5, wherein applying the electrical charge comprises applying a pulsating direct current to each pipe of the series of pipes.

7. The process of claim 4, further comprising charging the series of charged pipes with a rod extending longitudinally through a portion of the length of each pipe of the series of charged pipes.

8. The process of claim 7, wherein charging comprises applying an electrical charge to the rod within each pipe of the series of pipes.

9. The process of claim 8, wherein applying the electrical current comprises applying a positive component of an electrical circuit to a part of each pipe of the series of pipes and applying a negative component of the electrical circuit to a part of the rod within each pipe of the series of pipes.

10. The process of claim 1, wherein treating the water comprises treating the water with ozone from an ozone generator.

11. The process of claim 10, wherein treating the water with ozone from the ozone generator comprises treating the water with ozone from a cold plasma ozone generator.

12. A process for making concrete, comprising:
mixing water with cement and/or aggregate to form a slurry;
treating the slurry with ions or ozone to form a treated slurry; and
pouring the treated slurry so that it can harden into concrete.

13. The process of claim 12, wherein treating the slurry comprises exposing the slurry to an electrical current.

14. The process of claim 12, wherein treating the slurry comprises introducing ozone into the slurry.

15. A system for making concrete, comprising:
means for treating water with ions and/or ozon to form treated water; and
means for mixing the treated water with aggregate and cement.

16. The system of claim 15 wherein the means for treating water comprises an electrolysis system.

17. The system of claim 16 wherein the electrolysis system comprises an electrolysis tank.

18. The system of claim 16 wherein the electrolysis system comprises a series of charged pipes through which the water is configured to flow.

19. The system of claim 18, wherein each pipe of the series of pipes has a rod extending a longitudinally within a portion of the length of said each pipe.

20. The system of claim 18, wherein the each of the pipes in the series of pipes is configured to have an electrical charge thereon provided by an electrical current.

21. The system of claim 20, wherein the electrical current is a pulsating direct current.

22. The system of claim 20, wherein each of the rods in the series of pipes has an electrical charge thereon provided by said electrical current.

23. The system of claim 22, wherein the electrical current has a positive component that is applied to a part of the series of pipes and a negative component applied to a part of the rods within the series of pipes.

24. The system of claim 15, where the means for charging water comprises an ozone generator.

25. The system of claim 24, wherein the ozone generator is a cold plasma ozone generator.
